(19) United States
(12) Patent Application Publication
(10) Pub. No.: US 2002/0060720 A1
(43) Pub. Date: May 23, 2002

(54) Inkjet printhead

(76) Inventors: Moo-youl Kim, Seoul (KR); Jae-ho Moon, Suwon-si (KR)

Correspondence Address: Robert E. Bushnell, Suite 300, 1522 K Street, N.W., Washington, DC, 20005-1202, US

(21) Appl. No.: 09/971,763

(22) Filed: Oct. 9, 2001

(30) Foreign Application Priority Data
Oct. 6, 2000 (KR) 2000-58758

(51) Int. Cl. B41J 2/05

(52) U.S. Cl. 347/56

(57) ABSTRACT

An inkjet printhead is disclosed. The inkjet printhead having a base plate provided with a plurality of chambers to be filled with ink, a nozzle plate installed on the base plate and provided with orifices communicating with the respective chambers, a plurality of heaters for generating heat when respective currents are independently applied, and heating the ink in the respective chambers so that ink bubbles can be generated to eject respective ink droplets through the respective orifices, and a plurality of ink inlet passages for supplying ink from an ink reservoir to the respective chambers, wherein a plurality of grooves are formed at the inner wall of each of the ink inlet passages. With the above structure, since an ink refilling speed is enhanced by the grooves formed at the ink inlet passage increasing the surface area of the ink inlet passages, an ink refilling time becomes shorter and the overall printing speed of the printhead is enhanced.

### CLAIM OF PRIORITY

This application makes reference to, incorporates the same herein, and claims all benefits accruing under 35 U.S.C. §119 from my application entitled INK JET PRINTING HEAD filed with the Korean Industrial Property Office on Oct. 6, 2000 and there duly assigned Ser. No. 2000-58758.

### BACKGROUND OF THE INVENTION

1. Field of the Invention

The present invention relates to an inkjet printhead, and more particularly, to an inkjet printhead having an improved structure for refilling a chamber with a new supply of ink.

2. Description of the Related Art

Inkjet printheads are often made by semiconductor processing. In order to reduce costs and provide for easy mass production of inkjet printheads, the structure of the printhead is often determined by what structure is easy to manufacture via semiconductor processing. Generally, this results in ink refill vias that have smooth sidewalls as such a sidewall is easy to make in semiconductor processing. Smooth sidewalls, in semiconductor processing can pose a limit as to how fast an ink chamber can refill after an ejection of a droplet of ink, thereby limiting the speed by which a printhead prints. What is needed is a structure that can enhance print speed by quickening the time an ink chamber is refreshed with ink after ejection of a droplet of ink.

### SUMMARY OF THE INVENTION

It is an object of the present invention to provide an improved structure for an inkjet printhead.

It is further an object to provide a structure for an inkjet printhead that allows the inkjet printhead to operate at higher speeds.

It is yet another object of the present invention to provide a printhead having an improved structure capable of shortening the time required to refill the chamber with ink.

It is still another object of the present invention to provide a structure for an inkjet printhead where ink inlet passages used to refill an ink chamber after expelling ink have grooved sidewalls, allowing for a greater surface area in the ink inlet passages, resulting in quicker and more efficient refilling times and thus higher operational speeds.

Accordingly, to achieve the above objects, there is provided an inkjet printhead having a base plate provided with a plurality of chambers to be filled with ink, a nozzle plate installed on the base plate and provided with orifices communicating with the respective chambers, a plurality of heaters for generating heat when respective currents are independently applied, and heating the ink in the respective chambers so that ink bubbles can be generated to eject respective ink droplets through the respective orifices, and a plurality of ink inlet passages for supplying ink from an ink reservoir to the respective chambers, wherein a plurality of grooves are formed at the inner wall of each of the ink inlet passages.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a sectional view illustrating the internal structure of an inkjet printhead;

FIG. 2 is a sectional view illustrating the structure of an inkjet printhead according to the present invention; and

FIG. 3 is a perspective view illustrating a portion of the inkjet printhead shown in FIG. 2.

### DESCRIPTION OF THE PREFERRED EMBODIMENT

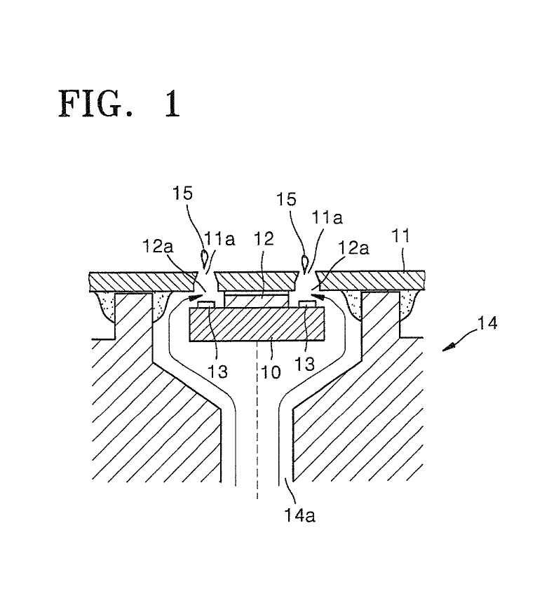

In general, an inkjet printhead is a device for ejecting droplets of ink for printing at desired positions on a recording paper sheet so as to print an image of predetermined colors, and, as shown in FIG. 1, having a base plate 10 installed at a position communicating with an ink inlet passage 14a of an ink cartridge 14, a partition wall layer 12 installed on the base plate 10 for partitioning chambers 12a which are to be filled with ink supplied through the ink inlet passage 14a, heaters 13 installed in the chambers 12a, and a nozzle plate 11 provided with orifices 11a through which ink droplets are ejected. In the above configuration, when each of the heaters 13 is selectively supplied with a current, the heater 13 generates heat, and bubbles are formed in ink filled in the corresponding chamber 12a. Then, expansion of volumes of the bubbles causes the pressure of the ink filled in the chamber 12a to increase, and the ink droplet 15 is ejected by the increased pressure to the outside through the orifice 11a. Thereafter, as ink is supplied to the chamber 12a through the ink inlet passage 14a, the chamber 12a is refilled with ink. At this time, a time required to refill the chamber 12a with ink is an important factor determining the printing speed of a printhead. That is, since when the required time is longer, a waiting time from one ink droplet ejection to the next ejection becomes longer, the printing speed becomes slower so much. Therefore, in order to enhance the printing speed, a printhead having a structure capable of shortening the time required to refill the chamber 12a with ink is required.

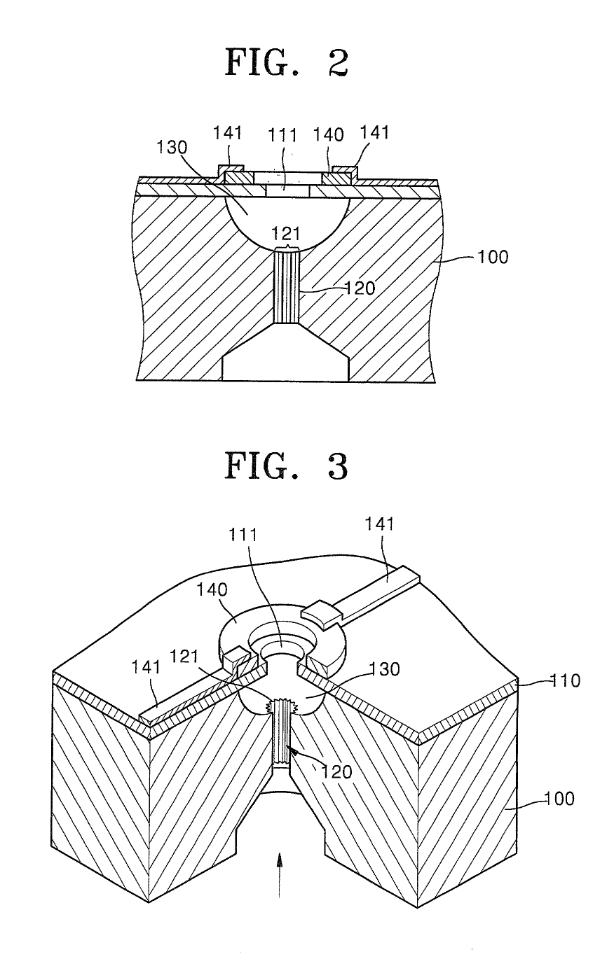

Referring to FIGS. 2 and 3, a nozzle plate 110 provided with orifices 111 is installed on a base plate 100. A heater 140 connected to electrodes 141 is installed on the outer side of the nozzle plate 110 around each orifice 111. In addition, chambers 130 in which ink supplied from an ink reservoir (not shown) via an ink inlet passage 120 are formed at the base plate 100 corresponding to the orifices 111, and when the heater 140 generates heat, the ink filled in the chamber 130 is indirectly heated with the nozzle plate 111 interposed therebetween. Here, a main characteristic of a printing head according to the present invention is that a plurality of grooves 121 are formed at the inner wall of the ink inlet passage 120. That is, in the structure of the present invention, the grooves 121 are formed at the inner wall of the ink inlet passage 120 in the form of vertical channels so that the surface area of the inner wall of the ink inlet passage 120 can be increased, and, therefore, ink can be supplied to the chamber 130 more efficiently.

In the above structure, the ink once supplied in the ink inlet passage 120 is filled in the chamber 130. In this state, when a current is supplied to the heater 140 via the electrodes 141, the heater 140 is instantaneously heated to about 400° C. to generate bubbles in the chamber 130, and an ink droplet is ejected to the outside through the orifice 111 by a pressure increase due to expansion of volumes of the bubbles. After the ink droplet is completely ejected as described above, ink is supplied from the ink reservoir to the chamber 130 via the ink inlet passage 120, and the chamber 130 is filled with ink. At this time, since the surface area of the ink inlet passage 120 is increased by the grooves 121, the ink refilling speed thereof is higher than the ink cartridge 40 of FIG. 1, and, therefore, a time required to refill the chamber 130 with ink becomes shorter. Consequently, since the ink refilling speed from the ink reservoir to the chamber 130 is enhanced due to the grooves 121 formed at the inner wall of the ink inlet passage 120, the overall printing speed of the printhead can be enhanced.

As described above, the printhead according to the present invention has an advantage in which an ink refilling time can be shorter and the overall printing speed thereof can be enhanced by forming grooves on the inner wall of the ink inlet passage to enhance the ink refilling speed.

What is claimed is:

1. An inkjet printhead, comprising:
a base plate provided with a plurality of chambers to be filled with ink;
a nozzle plate installed on the base plate and provided with orifices communicating with the respective chambers;
a plurality of heaters for generating heat when respective currents are independently applied, and heating the ink in the respective chambers so that ink bubbles can be generated to eject respective ink droplets through the respective orifices; and
a plurality of ink inlet passages for supplying ink from an ink reservoir to the respective chambers, wherein a plurality of grooves are formed at an inner wall of each of the ink inlet passages.

2. The inkjet printhead as claimed in claim 1, wherein the ink inlet passages are formed in the base plate.

3. The inkjet printhead as claimed in claim 1, wherein each of the heaters is installed on the outer side of the nozzle plate to heat the ink in the corresponding chamber indirectly via said nozzle plate by conduction.

4. The printhead of claim 1, each one of said plurality of chambers being hemispherical.

5. The printhead of claim 1, each of said plurality of ink inlet passages extends through said base plate.

6. The printhead of claim 4, each one of said plurality of ink inlet passages extend through said base plate to a bottom of a respective one of said plurality of hemispherical chambers.

7. An inkjet printhead, comprising:
a substrate provided with a plurality of chambers to be filled with ink;
a nozzle plate installed on top of the substrate and provided with orifices communicating with the respective chambers;
a plurality of heaters for generating heat when respective currents are independently applied, and heating the ink in the respective chambers so that ink bubbles can be generated to eject respective ink droplets through the respective orifices; and
a plurality of ink inlet passages extending through said substrate from bottoms of respective ones of said plurality of chambers for supplying ink from an ink reservoir to the respective chambers, wherein a plurality of grooves are formed at an inner wall of each of the ink inlet passages.

8. The printhead of claim 7, each of said plurality of chambers being hemispherical and being disposed at said top of said substrate, each of said plurality of ink inlet passages extending from bottoms of respective ones of said plurality of hemispherical ink chambers.

9. The printhead of claim 8, wherein each one of said plurality of heaters having a donut shape and encircling said orifices.

10. The printhead of claim 9, wherein said plurality of heaters are disposed on an underside of said nozzle plate and facing respective ones of said plurality of chambers.

11. The printhead of claim 9, wherein said plurality of heaters being disposed on a top side of said nozzle plate facing away from respective ones of said plurality of ink chambers and applying heat to ink in respective ones of said ink chambers by conduction of heat through said nozzle plate to said ink in said ink chambers.

12. An inkjet printhead, comprising:
a base plate being perforated by a plurality of hour-glass structures, a top portion of said hour glass portions being respective ones of a plurality of chambers to be filled with ink;
a nozzle plate installed on the base plate and perforated with a plurality of nozzle holes communicating with the respective chambers;
a plurality of heaters for generating heat when respective currents are independently applied, and heating the ink in the respective chambers so that ink bubbles can be generated to eject respective ink droplets through the respective nozzle holes; and
a plurality of ink inlet passages for supplying ink from an ink reservoir to the respective chambers, wherein a plurality of grooves are formed at an inner wall of each of the ink inlet passages.

13. The printhead of claim 12, a bottom of said hour glass portions being a plurality of funnels for drawing in ink to replenish respective ones of said ink chambers, said ink inlet passages connecting respective ones of said funnels with respective ones of said ink chambers and forming a middle portion of said hour-glass shaped perforations of said base plate.

14. The printhead of claim 12, each of said plurality of ink chambers being hemispherical and forming a top portion of said hour-glass perforation of said base plate.

15. The printhead of claim 12, each one of said plurality of heaters having a donut shape and encircling respective ones of said nozzle holes.

16. The printhead of claim 15, said plurality of heaters are disposed on an underside of said nozzle plate and facing respective ones of said plurality of chambers.

17. The printhead of claim 15, said plurality of heaters being disposed on a top side of said nozzle plate facing away from respective ones of said plurality of ink chambers and applying heat to ink in respective ones of said ink chambers by conduction of heat through said nozzle plate to said ink in said ink chambers.

18. The printhead of claim 13, each one of said plurality of heaters having a donut shape and encircling respective ones of said nozzle holes.

19. The printhead of claim 18, said plurality of heaters are disposed on an underside of said nozzle plate and facing respective ones of said plurality of chambers.

20. The printhead of claim 18, said plurality of heaters being disposed on a top side of said nozzle plate facing away from respective ones of said plurality of ink chambers and applying heat to ink in respective ones of said ink chambers by conduction of heat through said nozzle plate to said ink in said ink chambers.
